(19) United States
(12) Patent Application Publication
(10) Pub. No.: US 2008/0292528 A1
(43) Pub. Date: Nov. 27, 2008

(54) Methods of and systems for forming carbon based materials

(76) Inventor: Sadeg M. Faris, Pleasantville, NY (US)

Correspondence Address: REVEO, INC., 6 Skyline Drive, Hawthorne, NY, 10523, US

(21) Appl. No.: 11/891,033

(22) Filed: Aug. 6, 2007

Related U.S. Application Data
(63) Continuation-in-part of application No. 11/400,730, filed on Apr. 7, 2006.
(60) Provisional application No. 60/835,632, filed on Aug. 5, 2006.

(51) Int. Cl. C01B 31/02; C01B 31/00

(52) U.S. Cl. 423/445 R

(57) ABSTRACT

In general, a system and method of the present invention include a seed material (for receiving deposited carbon atoms) is provided with an active edge, for instance, at a growth line. A form of carbon is provided from a suitable source, and it is deposited upon the edge generally in a deposition region. The growth line is a position where the portion of the seed attracts the materials for growth. The source is activated to produce carbon (C, C2, other C forms) in a form that has a sufficiently low activity so that it will bond to the active edge (as opposed to oxidizing into other molecules such as carbon oxides). As the carbon material is deposited (i.e., atomically bonded) to the edge, the seed material may be pulled at a desired rate, i.e., to “grow” carbon material in the form of a sheet, ribbon, roll, tube, or many other desirable forms as described further herein.

### RELATED APPLICATIONS

This application claims the benefit under 35 U.S.C. § 119(e) of U.S. Provisional Application No. 60/835,632 filed on Aug. 5, 2006, and is a continuation in part of U.S. application Ser. No. 11/400,730 filed on Apr. 7, 2006 entitled “Probes, Methods of Making Probes, and Applications using Probes”; which are incorporated herein by reference.

### TECHNICAL FIELD

This invention relates generally to the field of materials, and more particularly to methods of and systems for forming carbon based materials.

### BACKGROUND ART

All life forms depend on hydrocarbons and all life forms are traced back to photosynthesis, or plants that provide food for other species. The photosynthetic process generates hydrocarbons, but never free carbon. It does it sequentially. First, the light reaction causes the splitting of the water by solar photons to release oxygen and keeps the hydrogen ions to be utilized as the energy source for the dark reaction which happens subsequently that involves the reduction of CO2 and the final production of hydrocarbon.

If we wanted to generate elemental carbon then we would combust the hydrocarbons. There is existing art that teaches how to convert carbon dioxide directly to carbon without the involvement of hydrogen.

Conventional carbon production techniques combust hydrocarbons to create carbon soot to selectively make certain allotropes of carbon. Traditionally, catalysts such as nickel, iron, and carbon have been used to catalyze the formation of carbon, but this happens only when the activation energy of the reaction is achieved by extremely high temperature achieved by the combustion process that releases the disassociation energy to overcome the barrier which by now is lowered by the catalyst.

Therefore, it would be highly desirable to provide methods to and systems for forming carbon based materials that overcome problems associated with conventional methods.

### BRIEF SUMMARY OF THE INVENTION

In general, a system and method of the present invention include a seed material (for receiving deposited carbon atoms) is provided with an active edge, for instance, at a growth line. A form of carbon is provided from a suitable source, and it is deposited upon the edge generally in a deposition region. The growth line is a position where the portion of the seed attracts the materials for growth. The source is activated to produce carbon (C, C2, other C forms) in a form that has a sufficiently low activity so that it will bond to the active edge (as opposed to oxidizing into other molecules such as carbon oxides). As the carbon material is deposited (i.e., atomically bonded) to the edge, the seed material may be pulled at a desired rate, i.e., to “grow” carbon material in the form of a sheet, ribbon, roll, tube, or many other desirable forms as described further herein.

The atomic carbon is generally created from its source material by a) the activity of the edge of free carbon atoms, e.g., an edge of a graphene layer, in combination with b) disassociation energy.

In certain embodiments, a method of forming a carbon material includes electrochemically reducing carbon oxide molecules. Some of the carbon oxide molecules disassociate into carbon and oxygen atoms. Certain free carbon atoms will bond to each other, described herein as self catalysis, and/or to a seed species, described herein in certain embodiments as nucleation (e.g., with a seed or catalyst) or auto-catalysis (e.g., examples herein where high active dangling atoms, for example, in embodiments described herein with single layer carbon edge such as a graphene edge). A system for forming a carbon material includes a source of carbon oxide molecules, or a directions structure such as a nozzle for directing flow to a deposition/growth region. An electrochemical reduction sub-system electrochemically reduces carbon oxide molecules.

In one aspect, at least some of said carbon atoms will bond to each other and form C2 allotropes when the distances between disassociated carbon atoms is sufficiently small to allow them to bond to one another, as opposed to returning back to carbon oxide state. Note that these C2 allotropes formed may further serve as seed species to attract other disassociated carbon atoms.

In another aspect of the above embodiment, at least some of said carbon atoms will bond to a seed species.

In another embodiment of the present invention, a method of forming a carbon material includes providing a seed species such as an active edge of atomic carbon layers as a desired potential well. A source of carbon oxide molecules is directed to the active edge, and a partial disassociation energy is applied to the carbon oxide molecules. The cumulative effect of the activity of the active edge and the partial disassociation energy cause at least a portion of the carbon oxide molecules to overcome the potential well and bond to the active edge.

In another embodiment of the present invention, a seed species is provided as a desired potential well. A source of atomic C is provided, and disassociation energy is applied at the seed species. Atomic C is disassociated and bonds to the seed species (e.g., an active edge of graphene) when the distance of said atomic C relative the seed species, the electrical conditions and optionally other energy sources allows atomic C to overcome a potential barrier to the desired potential well.

These embodiments of the present invention and others presented herein allow one to growing graphene sheets or carbon nanotubes, for example. Graphene sheets, for example, may be grown laterally in certain embodiments by direct reduction of carbon dioxide to carbon.

Unlike conventional combustion approaches that require extremely high temperatures, the catalytic activity according to certain embodiments of the present invention can take place at or approaching ambient temperature through electrochemical reduction of CO2. Therefore, the present invention provides profound and fundamental methods and systems since it affords the ability to use ambient or near-ambient temperatures, electrical potential to provide part of the driving force to overcome the barrier along with the barrier lowering that is achieved by the high active dangling atoms, for example, in embodiments described herein with single layer carbon edge, e.g., graphene edge.

### BRIEF DESCRIPTION OF THE FIGURES

The foregoing summary as well as the following detailed description of preferred embodiments of the invention will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings, where:

FIG. 1 is an overview of a system and method according to certain other embodiments of the present invention;

FIG. 2 shows representations of potential well diagrams associated with a carbon oxide (e.g., carbon dioxide) reduction process to provide a source of atomic carbon according to certain embodiments of the present invention;

FIG. 3 show an overall potential well diagram associated with a carbon oxide (e.g., carbon dioxide) reduction process to provide a source of atomic carbon according to certain embodiments of the present invention;

FIG. 4 shows the probability of attraction between disassociated atoms and an active site as related to distance therebetween;

FIG. 5 shows a quantum tunneling phenomenon that contributes in embodiments of the present invention

FIG. 6 shows an exemplary system according to certain embodiments of the present invention using a disassociation energy source to tip the potential barrier and allow for favorable carbon growth;

FIG. 7 is an overview of a system and method according to certain embodiments of the present invention using an electrochemical reduction disassociation energy;

FIGS. 8-10 are schematic representations of a system and method according to certain embodiments of the present invention showing a single atomic layer of carbon atoms as a seed for electrochemical reduction of carbon dioxide, and resultant grown carbon materials and oxygen gas byproduct;

FIG. 11 is an overview of a terrace growth inhibitor sub-system according to certain embodiments of the present invention;

FIG. 12 shows various terrace growth inhibitor sub-systems including buffer or barrier gas to prevent terrace growth;

FIG. 13 shows terrace growth inhibition with use of localized electric fields to increase the probability of the C atomic grown at the edge;

FIGS. 14 and 15 show various seed configurations according to different aspects of the present invention;

FIG. 16 shows another embodiment of the present invention utilizing a tubular structure whereby a C source such as CH4 is introduced at one end thereof, and disassociation occurs at the exiting end, e.g., incorporating highly active dangling carbon atoms to induce autocatalysis;

FIG. 17 shows another embodiment of the present invention whereby materials may be grown to virtually any desired dimension using various embodiments for forming carbon materials described herein.

FIG. 18 shows an energy diagram for life molecules and elements wherein, electrochemical reduction of CO2 according to embodiments of the present invention are shown from the left to center having a disassociating energy and an activation energy, and disassociation of water and hydrocarbons is shown from the right to center; and

FIG. 19 represents carbon allotrope energy levels;

### DESCRIPTION

Methods of and systems for forming carbon based materials are described herein.

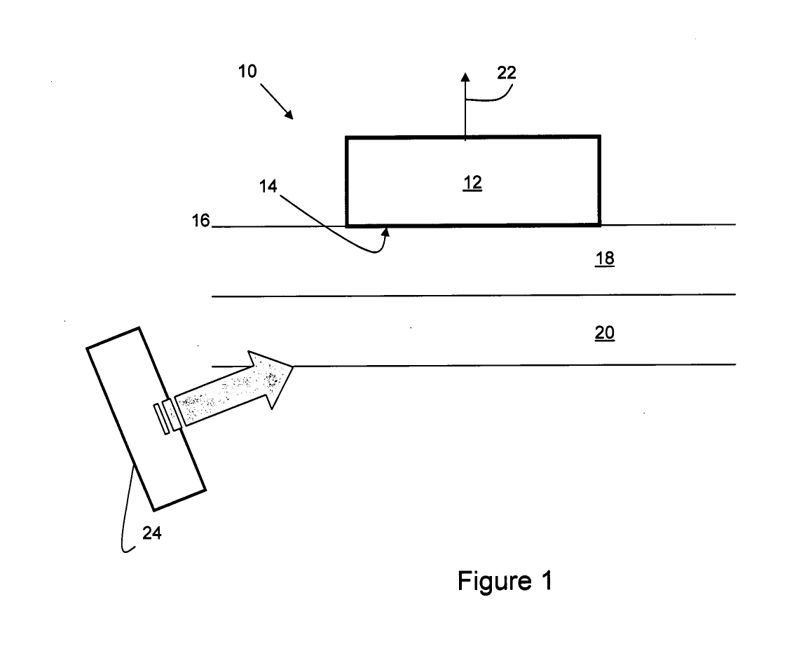

FIG. 1 shows a schematic overview of an embodiment of the present invention, where a seed material 12 is provided with an edge 14 at a growth line 16. A form of carbon is provided from a source region 20, and it is deposited upon the edge 14 generally in a deposition region 18. Deposition region 18 may extend from the edge 14 a distance on the order of a fraction of a nanometer to several nanometers, depending, for instance, on the conditions, seed characteristics, and desired rate of growth. The growth line 16 is the line where the portion of the seed (e.g., edge 14) that attracts the materials for growth. The source region 20 is activated to produce carbon (C, C2, other C forms) in a form that has a sufficiently low activity so that it will bond to the edge 14 at the growth region 16 (as opposed to oxidizing into other molecules such as carbon oxides). As the carbon material is deposited (i.e., atomically bonded) to the edge 14, the seed material 12 may be pulled 22 at a desired rate, i.e., to “grow” carbon material in the form of a sheet, ribbon, roll, tube, or many other desirable forms as described further herein.

The atomic carbon is generally created from its source material by a) the activity of the edge 14 of free carbon atoms, e.g., an edge of a graphene layer, in combination with b) a disassociation energy sub-system 24. The disassociation energy may be in the form of an electrical potential applied between a source or seed and an electrode, electromagnetic radiation, pressure, photodissociation, UV light, heat, plasma, impact ionization, impact dissociation, electromagnetic radiation, or combinations including at least one of the foregoing sources of disassociation energy to provide the kinetic energy to disassociate molecular carbon into atomic carbon.

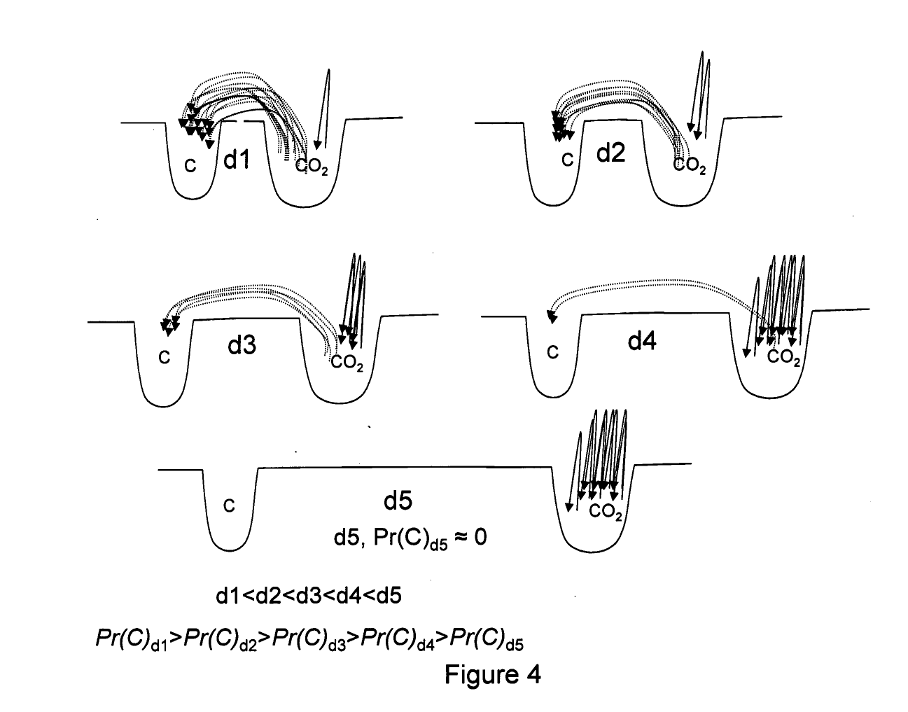

In certain embodiments of the present invention, at least some of the carbon atoms will bond to each other and form C2 allotropes when the distances between disassociated carbon atoms is sufficiently small to allow them to bond to one another, as opposed to returning back to carbon oxide state, e.g., as diagrammatically represented in FIG. 4, wherein Pr(C)_{dn} represents the probability of a carbon atom falling into the desired well based on the distance dn between the disassociated carbon atom and the well. Note that these C2 allotropes formed may further serve as seed species to attract other disassociated carbon atoms.

These embodiments of the present invention and others presented herein allow one to growing graphene sheets or carbon nanotubes, for example. Graphene sheets, for example, may be grown laterally in certain embodiments by direct reduction of carbon dioxide to carbon.

Various allotropes of carbon that may benefit from various embodiments of the present invention include: Carbon allotropes include: diamond; graphite; graphene; fullerenes (e.g., buckminsterfullerene or buckyball), chaoite; lonsdaleite; amorphous carbon; carbon nanofoam carbon nanotubes, aggregated diamond nanorods; lampblack (soot); and glassy carbon.

Unlike conventional combustion approaches that require extremely high temperatures, the catalytic activity according to certain embodiments of the present invention can take place at or approaching ambient temperature through electrochemical reduction of CO2. Therefore, the present invention provides profound and fundamental methods and systems since it affords the ability to use ambient or near-ambient temperatures, electrical potential (e.g., about 3 volts in certain embodiments) to provide part of the driving force to overcome the barrier along with the barrier lowering that is achieved by the high active dangling atoms, for example, in embodiments described herein with single layer carbon edge, e.g., graphene edge.

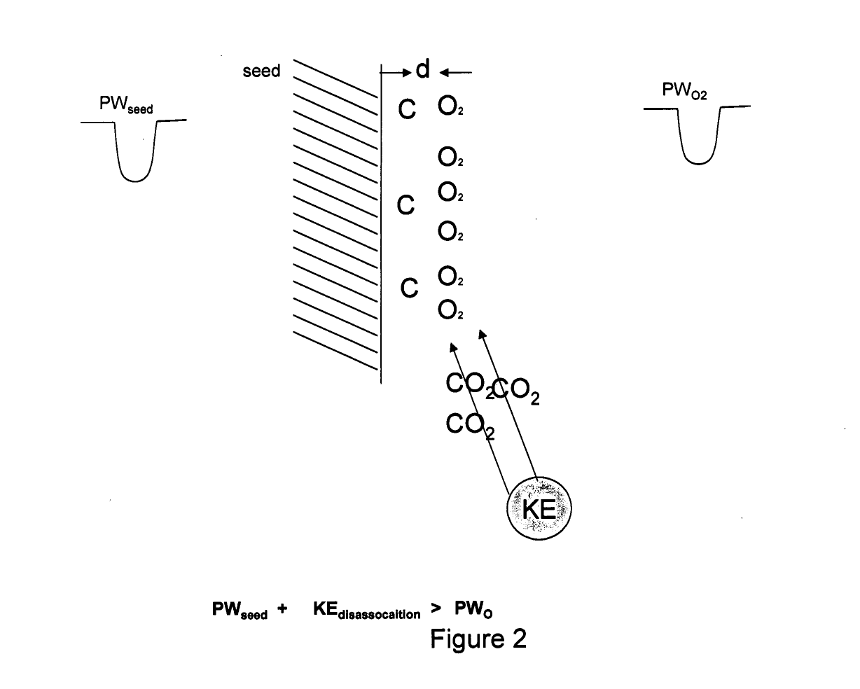

FIG. 2 shows representations of potential well diagrams associated with a carbon oxide (e.g., carbon dioxide) reduction process to provide a source of atomic carbon according to certain embodiments of the present invention. For the carbon atoms to be attracted to the seed, the sum of the potential well of the seed and the disassociation energy imparted (KE) must exceed the potential well of the oxygen. That is, if the sum is insufficient, the atomic carbon will not have sufficient energy to be expelled from the CO2 state and into the C well. PWO2 and PWseed represent the energy of the atomic carbon to be attracted to the oxygen or the seed, respectively. KE allows the barrier to be tipped to allow the atomic C to fall to the seed rather than back to the O2 when d is sufficiently small. The KE may be in the form of an electrical potential applied between a source or seed and an electrode (not shown), electromagnetic radiation, pressure, photodissociation, UV light, heat, plasma, impact ionization, impact dissociation, electromagnetic radiation, or combinations including at least one of the foregoing sources of disassociation energy to provide the kinetic energy to disassociate the CO2

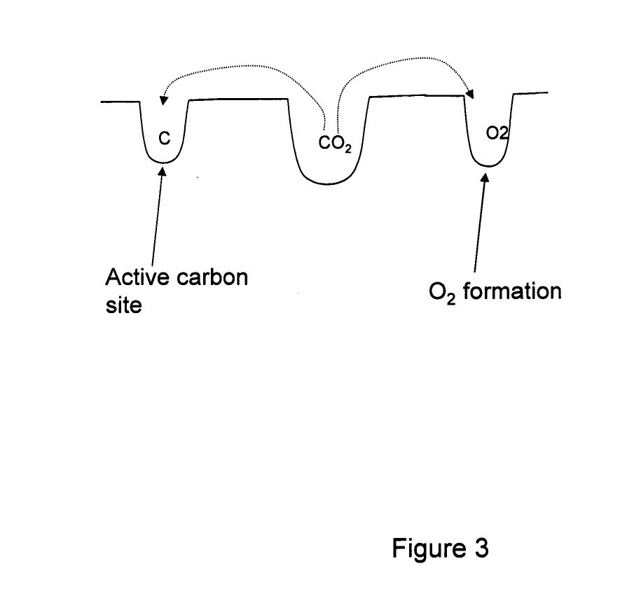

FIG. 3 shows a potential well diagram of CO2 disassociation. The imparted disassociation energy (e.g., the KE as shown in FIG. 2) and the activity at the free carbon site (e.g., the active edge or at least one free carbon atom) create favorable conditions to allow CO2 to disassociate into atomic C and fall into a potential well for C (wherein C2 or other allotropes are formed), and O2. In the absence of the free carbon site, or if the distance is too far, then CO2 will most likely disassociate into CO and O2 regardless of the applied disassociation energy. Ultimately, as growth continues, the C atoms that were deposited now provide the potential well for the next C atom to fall into.

FIG. 4 shows a series of potential wells diagrams showing that the probability of filling the potential well c increases as the distance decreases. the desired probability distribution based on distance between the atomic source and the active site. Pr(C)dn represents the probability of a carbon atom falling into the desired well based on the distance dn between the disassociated carbon atom and the well. The probability is higher as the energy imparted on the disassociated carbon from CO2. The distances for d1 through d4 may be on the order of less than a nanometer to a several nanometers. The distance d5 may be on the order of ten nanometers, wherein at that distance, the carbon well is too far away even for a disassociated carbon atom. Note that, for purposes of clarity, FIG. 4 does not show the potential well for trapping O2

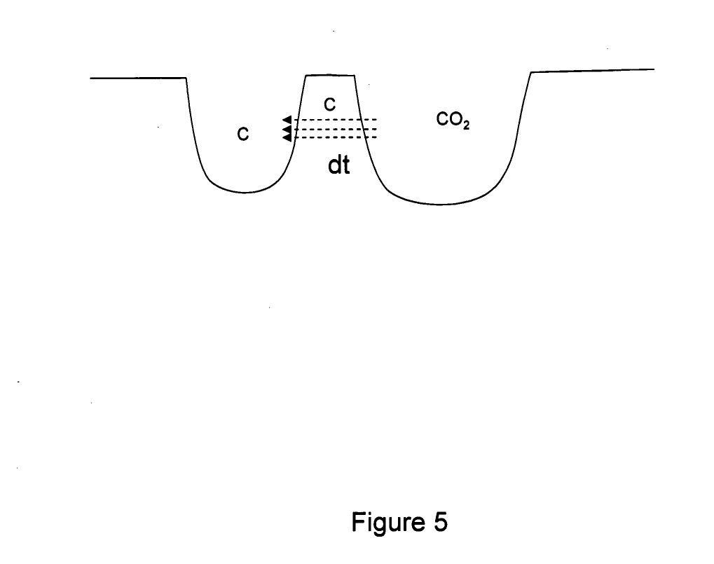

Referring now to FIG. 5, a potential well diagram is shown wherein quantum tunneling effects cause carbon atoms to be attracted to the free active carbon. At certain distances, the quantum mechanical phenomenon may contribute to attracting the atoms to the carbon well. The distance dt may be, for instance, on the order of about 0.2 to about 0.6 nanometers. Note that these dimensions may vary depending the repulsive forces of the free atom and the energy levels of the active site and the source (including disassociated atoms and molecules from the source).

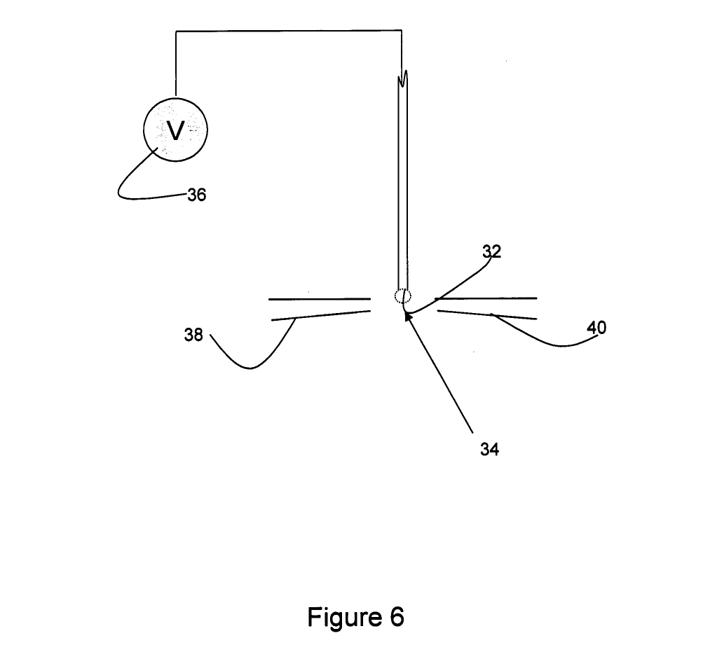

FIG. 6 shows one example of a carbon growth subsystem, wherein an active edge 32 is provided. A deposition region 34 is created by the active edge 32 in combination with a source of atomic carbon and a disassociation energy source. In order to a) increase activation of the edge; b) reduce the grown of terraces as described further herein; and c) reduce the amount of secondary disassociate energy required, electrical energy from a source 36 may be applied at one end, thereby creating a point field at the active edge 32. When carbon is provided from a source 40 (e.g., a suitable nozzle or probe), and upon application of disassociation energy from an energy source 38, carbon atoms bond to the free active site. These attached carbon atoms then become free active carbon sites for subsequent attraction of atomic carbon. Note that the source 40 may comprise suitable nozzles or solid probes as described in copending U.S. patent application Ser. No. 11/400,730 (Publication No. US 2007-0082459 A1), which is incorporated herein by reference.

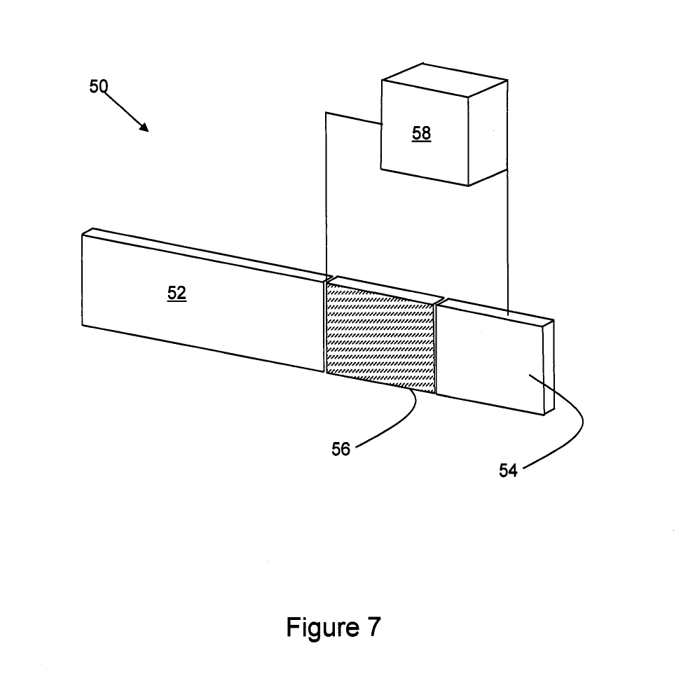

FIG. 7 shows a schematic diagram of embodiment of the present invention for forming carbon based material. A system 50 is provided including a seed material 12 and an electrode 14, wherein the seed material 12 and the electrode 14 have an electrolytic medium 16 therebetween. A voltage 18 is applied between the seed material 12 and the electrode 14. A seed material 12 is provided, for example, that provides an active site for attracting carbon. For instance, the seed material 12 may comprise an active edge of an atomic carbon layer (e.g., an edge of a sheet of graphene). Alternatively, other forms of seed material 10 may be provided, including any active site that has at least one free carbon atom. Carbon atoms are be bonded to the seed material 12, thereby causing growth thereof. The carbon atoms may be derived from the electrode 14, carbon atoms may be incorporated in the electrolytic medium 16, or carbon atoms may come from another source as described further herein.

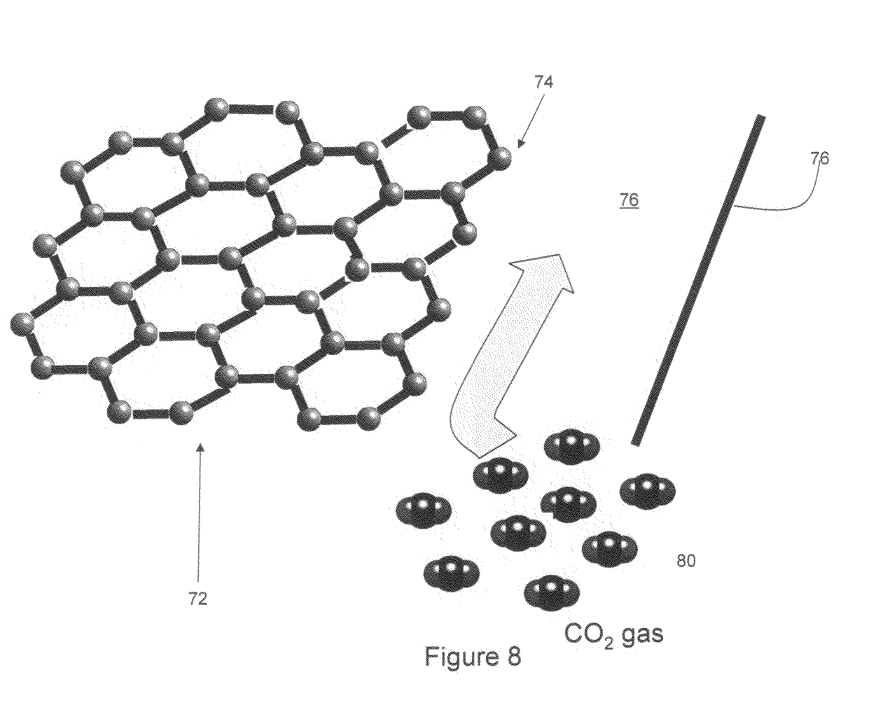

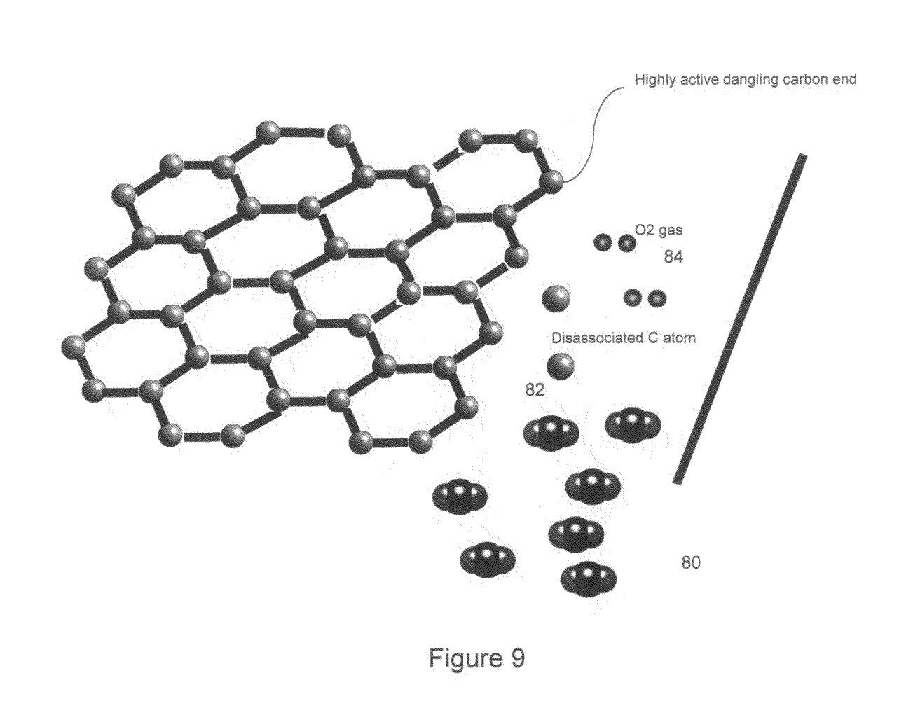

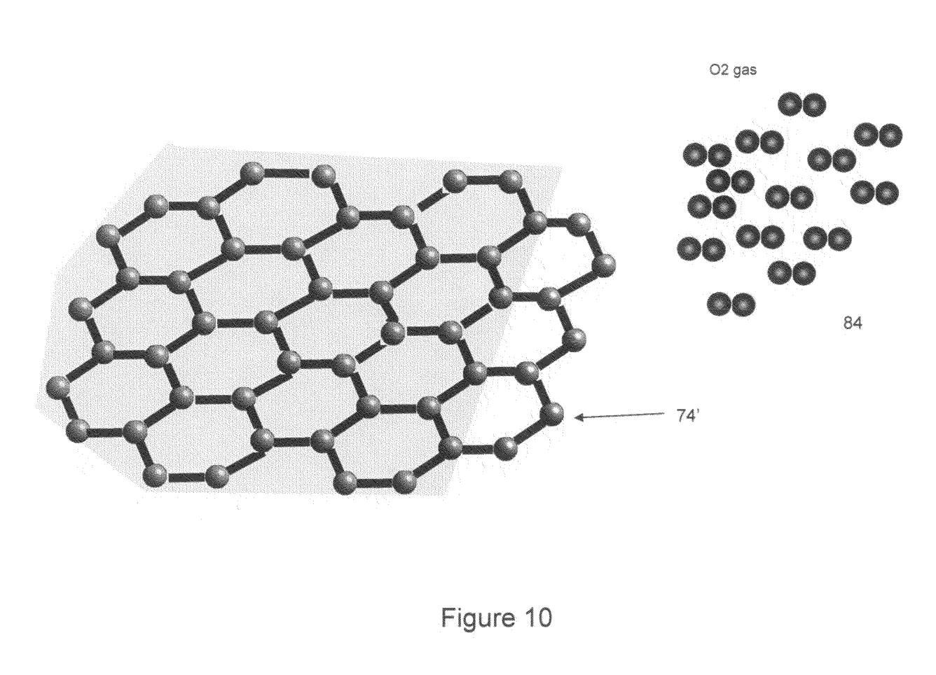

FIGS. 8-10 show schematic representations of a system and method according to certain embodiments of the present invention showing a single atomic layer of carbon atoms as a seed for electrochemical reduction of carbon dioxide, and resultant grown carbon materials and oxygen gas byproduct. For instance, a section 72 of carbon material (e.g., graphene) is provided with an active edge region 74. The edge region 74 is separated from an electrode 76 by suitable electrolytic medium 78. The carbon source comprises carbon oxide molecules 80, such as carbon dioxide molecules 80, which flow between the edge 76 and the electrode 78. When a suitable voltage is applied between the material 72 and the electrode 74, disassociation energy contributes to the electrochemical reduction of carbon dioxide (or other carbon oxide) into atomic carbon 82 and oxygen 84. As the distance d between the atomic carbon and the edge 74 decreases, the probability of the carbon atom 82 bonding to the edge 74 increases, as described further herein. Accordingly, the section 72 grows by having bonded thereto some of the carbon atoms 82 that were disassociated from the carbon oxide molecules 80, forming a new edge region 74′ (wherein the original section 72 is shaded in FIG. 10).

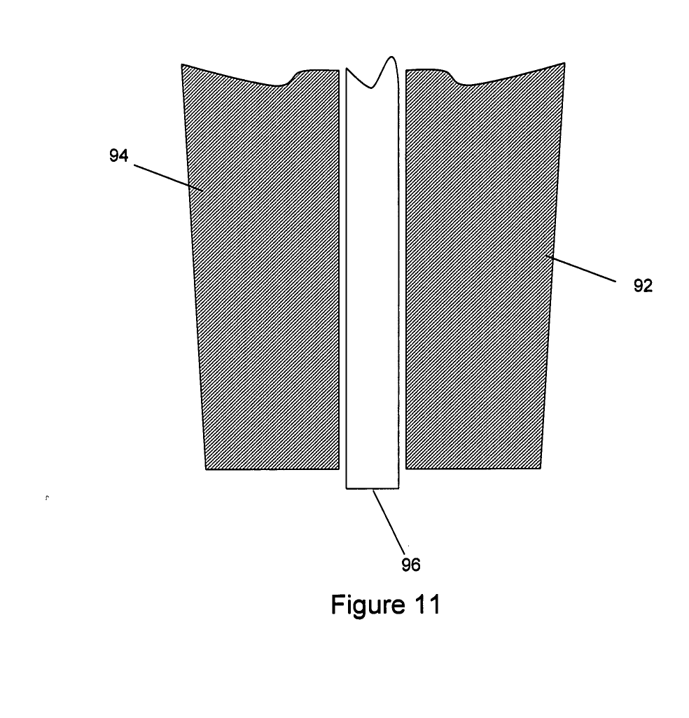

FIG. 11 shows one system for minimizing or eliminating the likelihood of terrace formations when growing carbon based materials, e.g., starting from a sheet of atomic carbon (graphene). Conventional processing of carbon material results in growth of so-called carbon terraces, that create multiple places of carbon material. In certain embodiments, it is desirable to eliminate these terraces. For instance, as shown in FIG. 11, physical structures 92, 94 may be placed on both face surfaces of a planar structure (or other major surface of a structure for which minimization of terrace grown is desired), leaving an exposed edge 96. This edge 96 may serve as a seed, or active carbon site, for use in various embodiments shown herein.

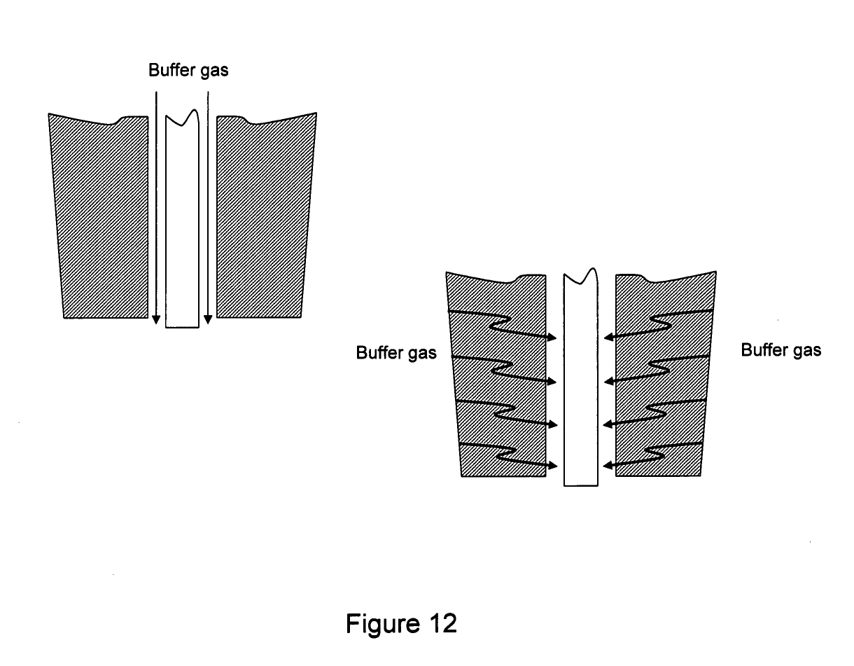

FIG. 12 shows alternative systems for inhibiting growth on planar surfaces of a seed, e.g., in the form of a sheet of atomic carbon (graphene). Buffer gas may be introduced in the direction of the plane of the sheet, or alternatively, one or more barrier gas streams may be introduced at another angle relative the sheet. This barrier gas minimizes the likelihood of terrace formation. In addition, utilizing any configuration of a gas barrier facilitates growth, for instance, in that as carbon atoms are deposited, the material having the active edge seed may be pulled.

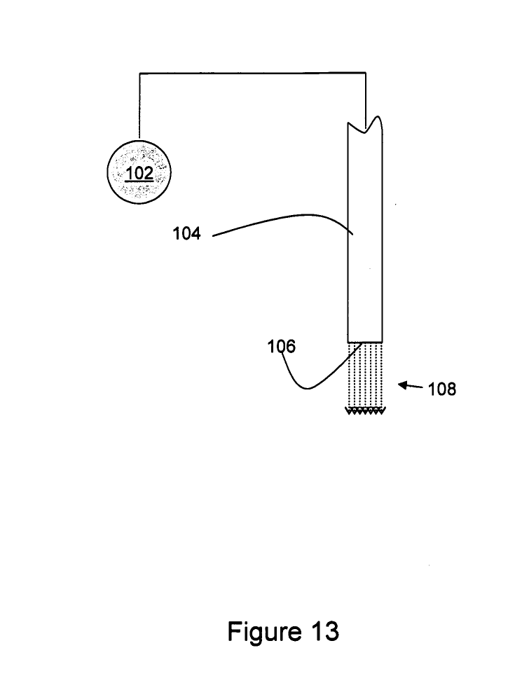

Referring now to FIG. 13, another embodiment of a system suitable for growing carbon materials is shown. A voltage source 102 is attached to a material 104, wherein the material 104 has an active edge 106. As voltage is applied, a localized electric field 108 is emitted from the edge. This phenomenon, known as dielectrophoresis (see, e.g., Zhang et al., “Efficient Fabrication of Carbon Nanotube Point Electron Sources by Dielectrophoresis”, Adv. Mater., 2004, 16, No. 14, Jul. 19, 1219-1222 for application of dielectrophoresis as a point electron source), results in an extremely focused electric field, which causes localized attraction for carbon growth. A potential well is created at the active end of the seed, which traps atomic carbon, and thus this active end becomes a nucleation site for carbon growth.

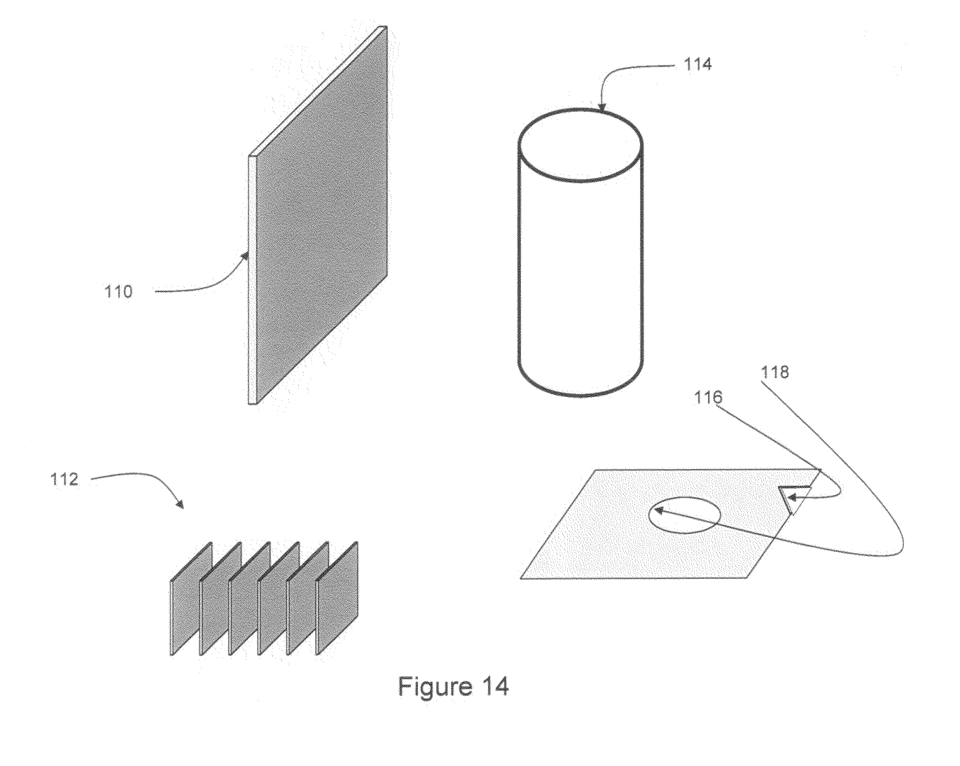

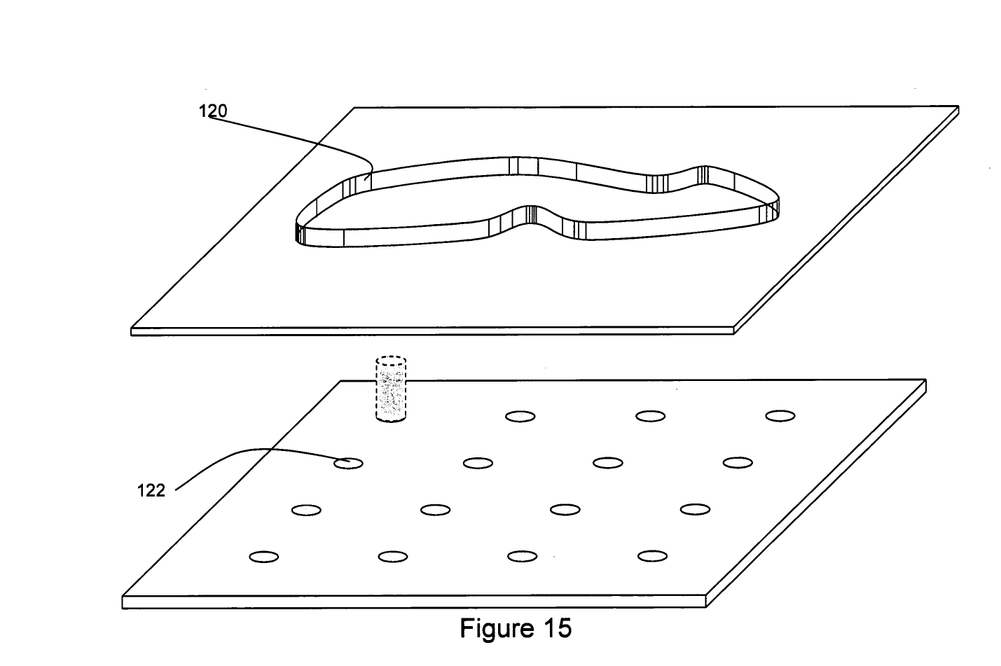

Referring now to FIGS. 14-15, various configurations are provided for the seed material. For instance, the seed may be an edge 110 of a planar structure, an array 112 of edges, an edge 114 of a nanotube, an edge 116 of a hole, or an edge 118 of a notch. Furthermore, plural edges an arbitrary shape 120 may be selected and used as a seed, e.g., to grow a structure having a desired cross section. Still further, an array 122 of seeds may be provided on a substrate to grow plural carbon material structures simultaneously. Numerous other possibilities exist. The shape of the starting seed may determine the final format of the grown carbon material structures, e.g., whether the material is formed in ribbons, spools, sheets, flakes rods, or tubes.

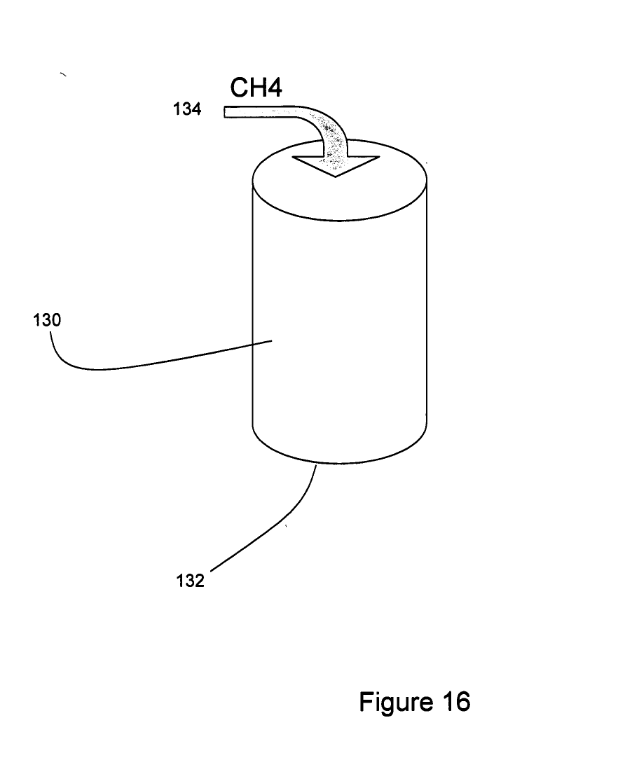

Referring now to FIG. 16, another embodiment of the present invention is provided. A carbon tube 130 (e.g., a nanotube) is provided, having an inlet side and an outlet side, the outlet side having an active edge 132. For example, a carbon containing molecule such as CH4 is disassociated at active edge due. When the distance is small enough between the CH4 molecules and the active edge, with some initial disassociation energy, atomic C will fall to the potential well created at the active edge and will remain trapped there. Ultimately, as growth continues, the C atoms that were deposited now provide the potential well for the next C atom to fall into.

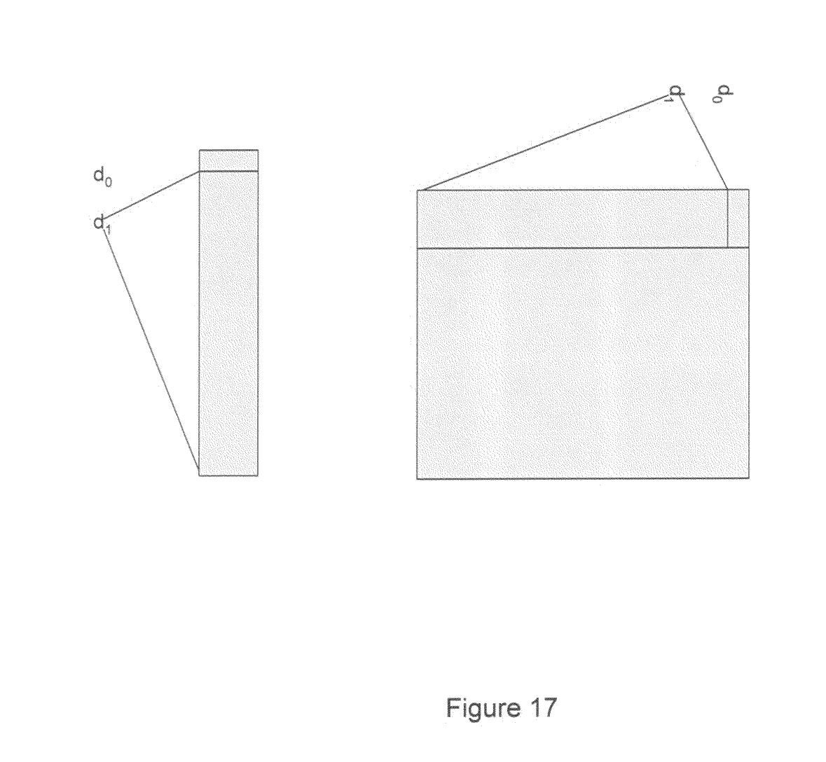

FIG. 17 shows a schematic illustration of steps to form a sheet of carbon material of any desired width. For instance, a starting seed d0 is provided. Using methods taught herein, the seed d0 is grown to a desired length d1+d0. Then, the material having a length d0+d1 is arranged to that its length serves as the active edge, and then grown to any desired length (having a width of d1+d0).

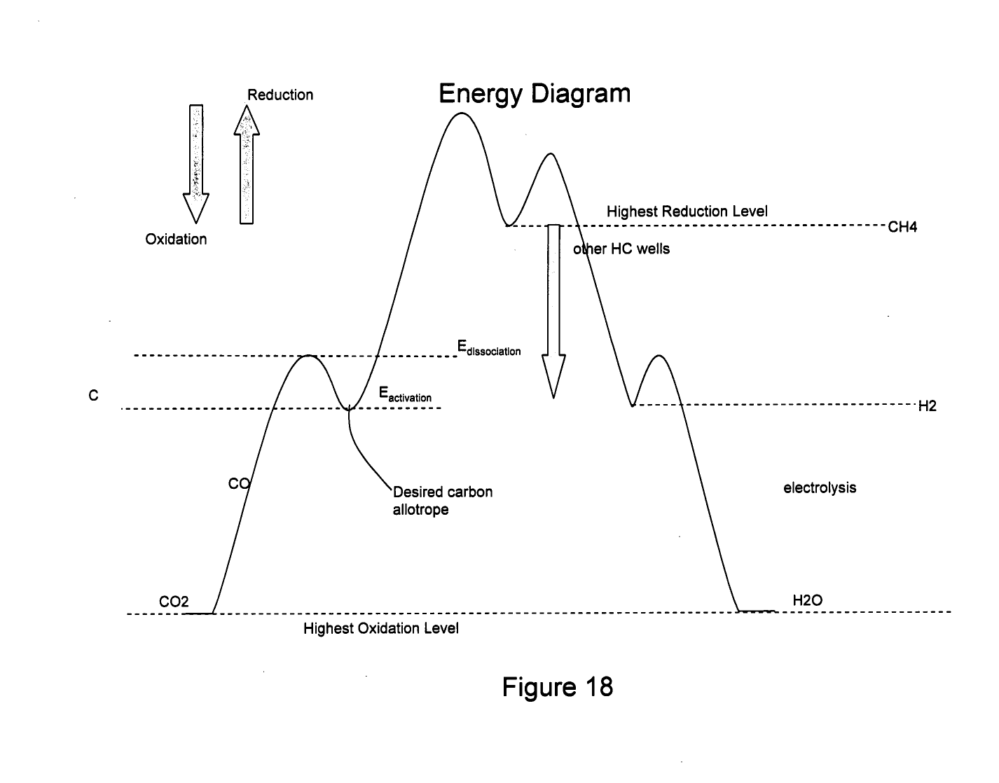

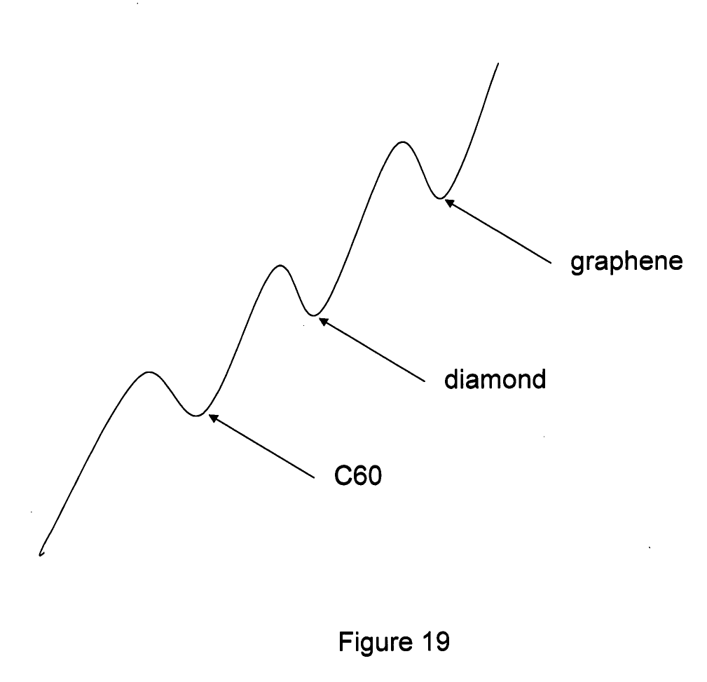

FIG. 18 is an energy diagram is shown, demonstrating respective potential well levels for various stages of the carbon cycle. FIG. 19 shows a carbon allotrope energy diagram.

While preferred embodiments have been shown and described, various modifications and substitutions may be made thereto without departing from the spirit and scope of the invention. Accordingly, it is to be understood that the present invention has been described by way of illustrations and not limitation.

1. A method of forming a carbon material comprising:
providing at least one active atomic carbon molecule as a desired potential well;
providing a source of atomic carbon;
wherein the activity of the at least one active atomic carbon molecule cause at least a portion of the carbon atoms to bond to the at least one active atomic carbon molecule.

2-10. (canceled)

11. The method as in claim 1, wherein the probability of carbon atoms bonding to a seed species increases with decreased distance of disassociated carbon atoms to the seed species.

12. The method as in claim 1, wherein said carbon oxide molecules comprises carbon dioxide.

13. The method as in claim 1, wherein the process occurs at temperatures below 50 degrees Celsius.

14. The method as in claim 1, wherein the process occurs at ambient temperature and pressure.

15. (canceled)

16. The method as in claim 1, wherein electrical energy is provided with a narrow energy distribution thereby producing a mono-energetic electron beam at the active edge so that disassociated C atoms have a narrow kinetic energy distribution as compared to non-mono-energetic electron beams and rate of C growth can be optimized.

17. The method as in claim 1, further comprising removing heat.

18-23. (canceled)

24. The method as in claim 1, wherein electrochemically reducing or providing the partial disassociation energy occurs within less than 5 atomic C diameters of free carbon atoms within a graphene layer.

25. The method as in claim 1, wherein electrochemically reducing or providing the partial disassociation energy occurs within less than 1 atomic C diameter of free carbon atoms within a graphene layer.

26. The method as in claim 1, wherein the seed species includes an active edge that is part of a planar structure having opposing face surfaces and the active edge, wherein atomic C is inhibited from growing at said face surfaces.

27. The method as in claim 26, wherein said atomic C is inhibited from growing at said face surfaces by virtue of more preferential focused electric field at the active edge as compared to the face surfaces.

28. The method as in claim 26, wherein said atomic C is inhibited from growing at said face surfaces by virtue of barrier gas.

29. The method as in claim 26, wherein the deposition region between a source of carbon oxide molecules and said active edge is sufficiently small to allow atomic C to be attracted to the seed species.

30. The method as claim 1, wherein an active edge of C serves as a catalyst.

31. The method as in claim 1, further wherein a catalyst is incorporated at the seed species.

32. The method as in claim 1, wherein said a partial disassociation energy or said energy source is selected from the group consisting of electrical energy, electromagnetic energy, thermal energy, plasma, and combinations comprising at least one of the foregoing energy sources.

33-37. (canceled)

38. The method as in claim 1 wherein the seed species comprises an active edge of a graphene layer

39-73. (canceled)
